(19) United States
(12) Patent Application Publication
(10) Pub. No.: US 2015/0273718 A1
(43) Pub. Date: Oct. 1, 2015

(54) Flexible Cutter Holder for a Cutting Plotter

(71) Applicant: GREAT COMPUTER CORPORATION, New Taipei City (TW)

(72) Inventors: Jih-Chiang YU, New Taipei City (TW); Chao-Fu CHIEN, New Taipei City (TW)

(73) Assignee: GREAT COMPUTER CORPORATION, New Taipei City (TW)

(21) Appl. No.: 14/225,954

(22) Filed: Mar. 26, 2014

(51) Int. Cl. B26D 7/26

(52) U.S. Cl. CPC B26D 7/2614; B26D 7/2628; B26D 2007/2678; B26D 2007/2685

(57) ABSTRACT

A flexible cutter holder for a cutting plotter for movably connecting to a track of the cutting plotter, comprising an upper cutter holder, a cutter, a lower cutter holder, and a flexible member. The upper cutter holder has a receiving space for disposing a thimble therein. The cutter is provided in the receiving space of the upper cutter holder below the thimble. The lower cutter holder is provided below the upper cutter holder and it has a through aperture for penetratingly disposing the cutter therein. The flexible member is provided between the upper cutter holder and the lower cutter holder, so as to increase the outward protruding length of the cutter from the bottom of the lower cutter holder when the bottom of lower cutter holder is pressed upwards by a workpiece.

### FIELD OF THE INVENTION

The present invention relates to a flexible cutter holder for a cutting plotter, and more particularly to one provided with a flexible member, so that the outward protruding length of the cutter can be adjusted by pressing. The structure provided by the present invention is simple and needs no manual adjustment. Moreover, it can significantly reduce the working period and improve the precision of cutting.

### BACKGROUND OF THE INVENTION

To cut a pattern on a piece of paper or a plastic paster, the required pattern is first generated by computer graphics programs, and then it is cut by moving the cutter on the piece of paper or the plastic paster by a cutting plotter following the input route of the pattern.

Generally speaking, a conventional cutter holder is assembled by screwing the cutter to a slider with a cutter disposed in a C-shaped section and screwed to a bolt fixedly. Because different materials are of different thickness, it is needed to adjust the outward protruding length of the cutter manually for cutting different materials. It is not only inconvenient and time consuming, but also has the risk of cutting hands. Thus, the conventional scheme is far from an ideal one.

### SUMMARY OF THE INVENTION

The main object of the present invention is to provide a flexible cutter holder for a cutting plotter which has simple structure, low cost, needs no manual adjustment, and can improve the precision of cutting.

To reach the object stated above, the present invention provides a flexible cutter holder for a cutting plotter for movably connecting to the track of the cutting plotter, which comprises an upper cutter holder, a cutter, a lower cutter holder, and a flexible member. The upper cutter holder has a receiving space for disposing a thimble therein. The cutter is provided in the receiving space of the upper cutter holder below the thimble. The lower cutter holder is provided below the upper cutter holder and it has a through aperture for penetratingly disposing the cutter therein. The flexible member is provided between the upper cutter holder and the lower cutter holder, so as to increase the outward protruding length of the cutter from the bottom of the lower cutter holder when the bottom of lower cutter holder is pressed upwards by a workpiece.

In implementation, the flexible member is mounted on the outer surface of the bottom of the upper cutter holder and the inner surface of the top of the lower cutter holder, so that the lower cutter holder is displaceable at the bottom of the upper cutter holder by stretching the flexible member.

In implementation, the flexible member is a spring.

In implementation, the top of the thimble protrudes outwardly through the top of the upper cutter holder.

In implementation, the blade edge at the lower end of the cutter partially protrudes through the bottom of the lower cutter holder.

The present invention will be understood more fully by reference to the detailed description of the drawings and the preferred embodiments below.

### BRIEF DESCRIPTION OF DRAWINGS

FIG. 1 is a perspective view of an embodiment of the present invention.

FIG. 2 is a partial breakdown drawing of an embodiment of the present invention before being assembled.

FIG. 3 is a sectional view of an embodiment of the present invention after being assembled.

FIG. 4 is a schematic view showing the status of the cutting operation on a workpiece of thinner thickness in an embodiment of the present invention.

FIG. 5 is a schematic view showing the status of the cutting operation on a workpiece of thicker thickness in an embodiment of the present invention.

### DETAILED DESCRIPTIONS OF PREFERRED EMBODIMENTS

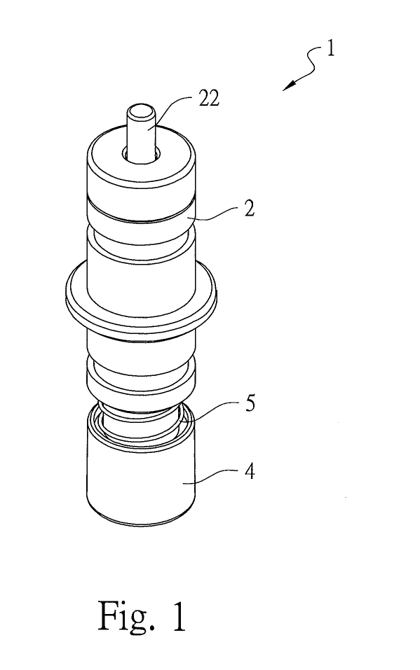

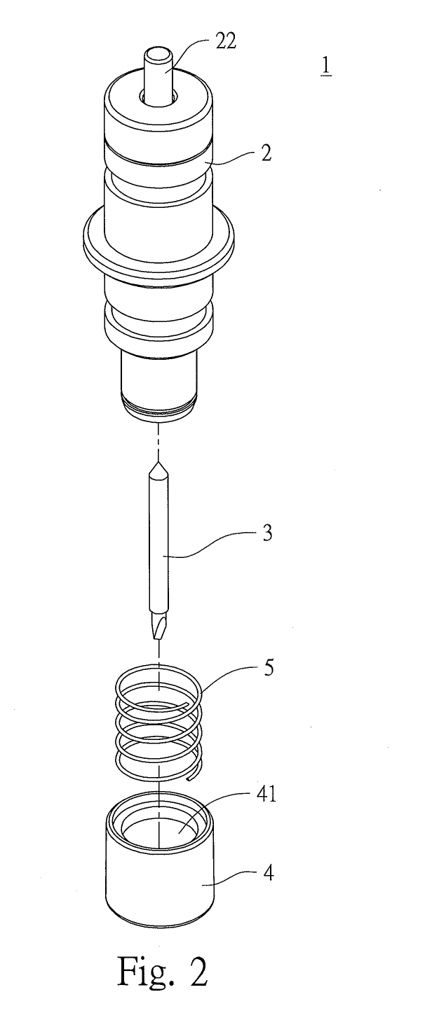

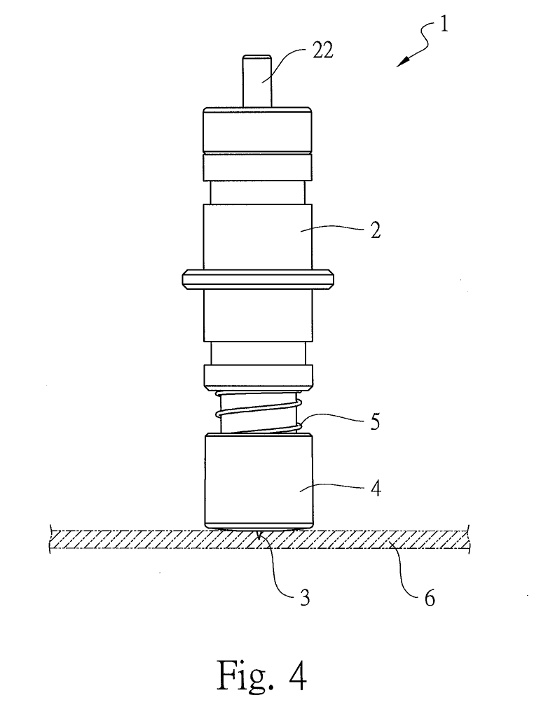

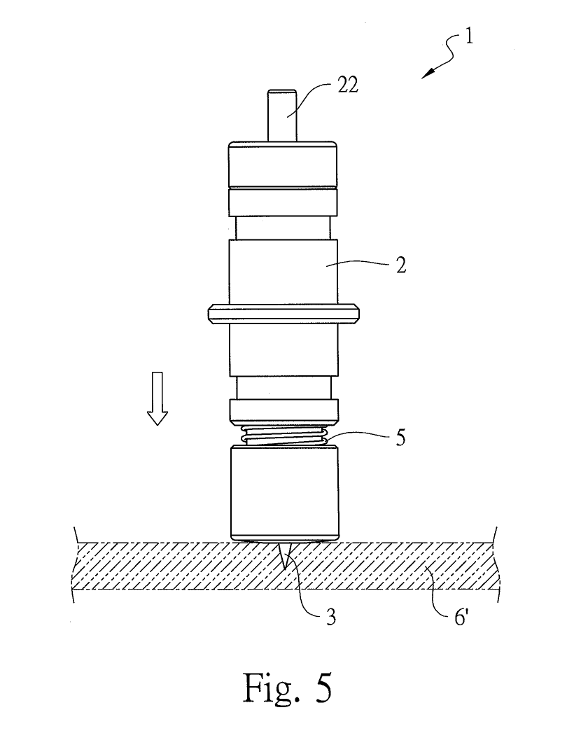

Please referring to FIG. 1-5, the figures show a flexible cutter holder 1 for a cutting plotter for movably connecting to the track of the cutting plotter according to the most preferred embodiment of the present invention, which mainly comprises an upper cutter holder 2, a cutter 3, a lower cutter holder 4, and a flexible member 5.

As shown in FIG. 1-3, the upper cutter holder 2 has a receiving space 21 for disposing a thimble 22 therein, and thimble 22 protrudes outwardly through the top of the upper cutter holder 2.

The cutter 3 is provided in the receiving space 21 of the upper cutter holder 2 below the thimble 22, and the blade edge at the lower end of the cutter 3 partially protrudes through the bottom of the lower cutter holder 4.

The lower cutter holder 4 is provided below the upper cutter holder 2, and it has a through aperture 41 for penetratingly disposing the cutter 3 therein.

The flexible member 5 is mounted on the outer surface of the bottom of the upper cutter holder 2 and the inner surface of the top of the lower cutter holder 4, so that the lower cutter holder 4 is displaceable at the bottom of the upper cutter holder 2 by stretching the flexible member 5. When the bottom of lower cutter holder 4 is pressed upwards by a workpiece 6, the outward protruding length of the cutter 3 from the bottom of the lower cutter holder 4 can be increased.

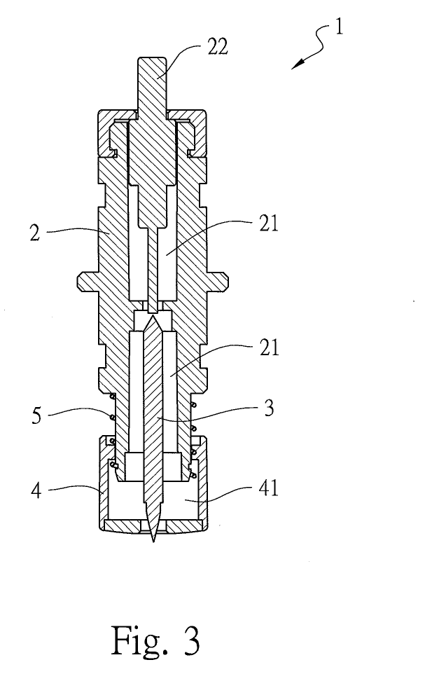

In implementation, please referring to FIGS. 3, 4, and 5, after assembling the cutter holder, because the blade edge at the lower end of the cutter 3 partially protrudes through the bottom of the lower cutter holder 4, the cutting operation on a workpiece 6 of thinner thickness can be performed. To perform the cutting operation on a workpiece 6′ of thicker thickness, the cutting plotter can control the cutter holder 1 provided by the present invention moving downward toward the workpiece 6′. When the bottom of lower cutter holder 4 presses downward against the workpiece 6′, it is pressed upwards by the workpiece 6′, leading to the compression of the flexible member 5 mounted on the outer surface of the bottom of the upper cutter holder 2 and the inner surface of the top of the lower cutter holder 4. The lower cutter holder 4 is therefore able to displace upwardly, so that the outward protruding length of the cutter 3 from the bottom of the lower cutter holder 4 can be increased.

Therefore, when the cutter 3 protrudes a specific length from the bottom of the lower cutter holder 4, the cutting operation on the workpiece 6′ of thicker thickness can be performed. Surely, the outward protruding length of the cutter 3 is adjusted by controlling the flexible cutter holder 1 of the present invention for the cutting plotter according to the required cutting depth on the workpiece 6/6′ of different thickness. After finishing the cutting operation, the flexible member 5 recovers once the lower cutter holder 4 departs from the workpiece 6′, and therefore the cutter 3 can move back to the original position. Moreover, the cutter 3 can be changed by pressing the thimble 22 downward to push out the cutter 3.

Therefore, through the design described above, there is no need to manually adjust the cutter for different workpiece, and an efficient cutting operation can be achieved. Not only it can reduce the working period, but also improve the precision of cutting, and the working accident owing to the manual adjustment can be prevented.

The description referred to the drawings stated above is only for the preferred embodiments of the present invention. Many equivalent local variations and modifications can still be made by those skilled at the field related with the present invention and do not depart from the spirit of the present invention, so they should be regarded to fall into the scope defined by the appended claims.

What is claimed is:

1. A flexible cutter holder for a cutting plotter for movably connecting to a track of the cutting plotter, comprising:
an upper cutter holder, having a receiving space for disposing a thimble therein;
a cutter, provided in the receiving space of the upper cutter holder below the thimble;
a lower cutter holder, provided below the upper cutter holder, having a through aperture for penetratingly disposing the cutter therein; and
a flexible member, provided between the upper cutter holder and the lower cutter holder, so as to increase the outward protruding length of the cutter from the bottom of the lower cutter holder when the bottom of lower cutter holder is pressed upwards by a workpiece.

2. The flexible cutter holder for a cutting plotter according to claim 1, wherein the flexible member is mounted on the outer surface of the bottom of the upper cutter holder and the inner surface of the top of the lower cutter holder, so that the lower cutter holder is displaceable at the bottom of the upper cutter holder by stretching the flexible member.

3. The flexible cutter holder for a cutting plotter according to claim 2, wherein the flexible member is a spring.

4. The flexible cutter holder for a cutting plotter according to claim 1, wherein the flexible member is a spring.

5. The flexible cutter holder for a cutting plotter according to claim 1, wherein the top of the thimble protrudes outwardly through the top of the upper cutter holder.

6. The flexible cutter holder for a cutting plotter according to claim 1, wherein the blade edge at the lower end of the cutter partially protrudes through the bottom of the lower cutter holder.
